(19) United States
(12) Patent Application Publication
(10) Pub. No.: US 2008/0183816 A1
(43) Pub. Date: Jul. 31, 2008

(54) METHOD AND SYSTEM FOR ASSOCIATING A TAG WITH A STATUS VALUE OF A PRINCIPAL ASSOCIATED WITH A PRESENCE CLIENT

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/669,339

(22) Filed: Jan. 31, 2007

(51) Int. Cl. G06F 15/16

(52) U.S. Cl. 709/204

(57) ABSTRACT

Methods and systems are described for associating a tag with a status value of a principal. One method includes receiving, from a client of a presence service associated with a first principal, a first status value associated with the first principal and sending, via the presence service, a first message including the first status value to a presence client of the presence service associated with a second principal. A tag associated with the first status value of the first principal is received from the client associated with the second principal. The tag is distinct from the first status value. An association between the received tag and the first status value is stored. Thereafter, when a status of the first principal is updated to the first status value, a second message that includes the tag is provided to the client associated with the second principal so that the tag is presented to the second principal.

### CROSS-REFERENCE TO RELATED APPLICATIONS

The present application is related to co-pending U.S. patent application Ser. No. 11/609,405, entitled “METHOD AND SYSTEM FOR ANNOTATING PRESENCE INFORMATION,” filed on Dec. 12, 2006, commonly owned with the present application, and incorporated here by reference in its entirety.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

In today's presence systems, presence information about a user or a device provides some useful information about the user or the device. For example, the status of the user or device may be known via a presence system. Further, any information the owner of a presence tuple publishes to the presence tuple may be presented to a watcher, which is a presence entity that receives presence information from a presence service on behalf of a presence client.

Generally, two categories of status can be provided by most presence applications: 1) pre-specified status values and 2) so called “custom status” values, which are any string up to a an allowable length that a user wishes to provide as status. Both categories are typically designed for communications between humans and between humans who speak the same language. This can present problems because a pre-specified status value or a custom status value in a first language might be meaningful to the publisher who understands the first language, but meaningless to a recipient who does not understand in the first language.

Moreover, devices, as well as humans, can be presence clients that publish and receive presence information including status values. Given the variety of devices that can utilize presence services, the pre-specified status values currently supported would have little or no meaning to many devices. Further, given the wide range of device types from various manufacturers and deployed by even more owning entities, it would be extremely difficult for a particular human user to devise a custom status value that is meaningful to or understood by any particular device.

### SUMMARY

In one aspect of the subject matter disclosed herein, a method for associating a tag with a status value of a principal is disclosed. The method includes receiving, from a client of a presence service associated with a first principal, a first status value associated with the first principal and sending, via the presence service, a first message including the first status value to a presence client of the presence service associated with a second principal. A tag associated with the first status value of the first principal is received from the client associated with the second principal. The tag is distinct from the first status value. An association between the received tag and the first status value is stored. Thereafter, when a status of the first principal is updated to the first status value, a second message that includes the tag is provided to the client associated with the second principal so that the tag is presented to the second principal.

In another aspect of the subject matter disclosed herein, a system for associating a tag with a status value of a principal is disclosed. The system includes a publication handler component configured to receive from a client of a presence service associated with a first principal, a first status value associated with the first principal, and a notification handler component configured to send a first message including the first status value to a client of the presence service associated with a second principal. The system also includes a tag handler component configured to receive from the client associated with the second principal a tag that is distinct from the first status value and is associated with the first status value of the first principal. The tag handler component is also configured to store an association between the received tag and the first status value of the first principal in a data store. A subscription handler component is configured to provide, based on the association, a second message including the tag to the client associated with the second principal when a status of the first principal is updated to the first status value.

In another aspect of the subject matter disclosed herein, a method for associating a tag with a status value of a principal is disclosed. The method includes receiving, by a client of the presence service associated with a second principal, a first message including a first status value associated with a first principal. The first message is sent from a presence service. A tag distinct from the first status value and associated with the first status value of the first principal is received. In addition, metadata for the tag that includes at least one condition that determines when the tag is associated with the first status value of the first principal is also received. An association between the tag, its metadata and the first status value is stored. When a status of the first principal is updated to the first status value and when each of the at least one conditions is satisfied, the tag is presented.

In another aspect of the subject matter disclosed herein, a system for associating a tag with a status value of a principal is disclosed. The system includes a a watch list monitor component configured to receive, from a presence service, a first message including a first status value associated with a first principal. The system also includes a tag association component configured to receive a tag associated with the first status value of the first principal, to receive metadata for the tag, the metadata including at least one condition that determines when the tag is associated with the first status value of the first principal, and to store an association between the tag, its metadata and the first status value. The system includes a display configured to present the tag when a status of the first principal is updated to the first status value and when each of the at least one conditions is satisfied.

### DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating an exemplary system according to an exemplary embodiment;

FIG. 2 is a block diagram illustrating an exemplary server according to one exemplary embodiment;

FIGS. 3A-3C are exemplary data formats for storing tag association information according to one embodiment;

FIG. 4 is a block diagram illustrating an exemplary client device according to one exemplary embodiment;

FIGS. 5A and 5B illustrate exemplary user interfaces/displays according to an exemplary embodiment; and

FIG. 6 a flow diagram illustrating a method for associating a tag with a status value of a principal according to an exemplary embodiment.

### DETAILED DESCRIPTION

According to aspects of the invention, methods, systems, and computer program products for associating a tag with a status value of a principal are disclosed. Well known presence protocols, such as XMPP-IM, SIP SIMPLE, and RVP, are used by presence services, and Jabber Software Foundation's pub/sub protocol as specified in Jabber Enhancement Proposal (JEP) JEP0060: Publish-Subscribe.

The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence”, each of which are published and owned by the Internet Society and incorporated here in their entirety by reference.

Generally speaking, one or more pub/sub servers are used to provide pub/sub services. The function of a pub/sub server, however, can be incorporated, either in whole or in part, into other entities. For example, according to the presence service model described in RFC 2778, two distinct agents of a presence service client are defined. The first of these agents, called a “presentity” (combining the terms “presence” and “entity”), provides presence information to be stored and distributed throughout the presence service on behalf of a presence client. The second type of presence agent is referred to as a “watcher”. Watchers receive presence information from a presence service on behalf of a presence client.

The presence model of RFC 2778 describes two types of watchers, referred to as “subscribers” and “fetchers”. A subscriber requests notification from the presence service of a change in some presentity client's presence information. The presence service establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

By way of example, aspects of an exemplary embodiment described here can employ a presence protocol as the pub/sub communication protocol. It should be understood, however, the relevant techniques described here can be performed using any pub/sub communications protocol as defined herein. Additionally, the exemplary embodiment described herein is not limited to the use of a pub/sub protocol for all communications described. Other known protocols can also be used.

According to pub/sub communication protocols, the pub/sub service stores and organizes information provided by the publisher and by the subscriber in data entities referred to as tuples. A tuple, in its broadest sense, is a data object containing one or more elements. If a tuple contains a status element it is referred to as a presence tuple (RFC 2778) and the information stored in the status element is referred to as presence information. Presence information can include a status value that indicates the status, e.g., availability, of a principal associated with the tuple. A pub/sub service which processes presence tuples is referred to as a presence service. In addition to containing a status element, a presence tuple can include any other content.

A tuple can represent any element used to store the published information associated with a publisher or principal. The published information may include general contact information of the publisher, such as name, telephone number, email address, postal address, an IP addresses or URLs associated with the publisher, and the like, as well as other data or content. As used here, a tuple can also be a representation that maps field names to certain values to indicate that an entity or object (e.g., the principal) includes certain components, information, and/or perhaps has certain properties.

According to an aspect, a method and system for associating a tag with a status value of a presentity representing a principal are described. As used herein, a tag is a word or phrase, image, or media stream associated with a resource, e.g., document, file, device, principal, or data item. For example, a tag can be a descriptive phrase that identifies the resource or some characteristic of the resource.

In one embodiment, a watcher, representing a principal, who subscribes to a status of another principal receives, via a presence service, a status value of the other principal when the presentity of the other principal publishes a status change. When the subscribing watcher receives a first status value of the other principal, a tag can be associated with the first status value so that, in the future, when the other principal's status is updated to the first status value, the tag is presented to the subscribing principal. In one embodiment, a tag can be shared among clients of the presence service. Moreover, a particular status value can be associated with a set of tags within a given context such as a group of coworkers. Thus, a search on a tag can identify all principals in the group with a status value from the tag group. By allowing the subscribing principal to associate a tag with the published status value of another principal, the tag can be presented to the subscribing principal, in place of, or in addition to, the status value. Accordingly, if the subscribing and publishing principals are humans who speak different languages, or are different devices, the subscribing principal can understand the status value published by the other principal.

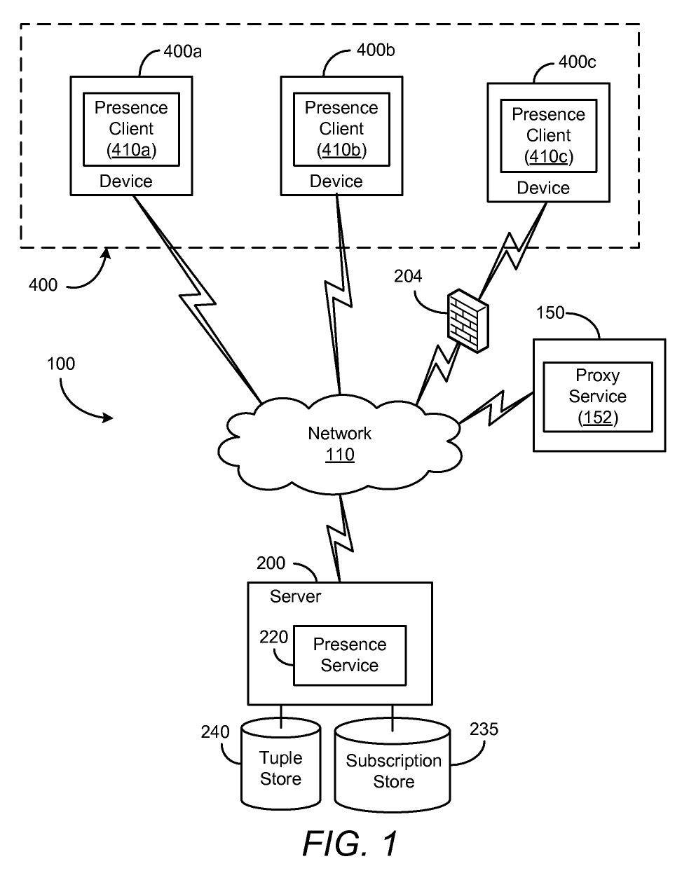

FIG. 1 is a block diagram illustrating an exemplary system according to one embodiment. The system 100 includes a plurality of client devices 400 in communication with a server 200 that hosts a presence service 220. Example types of such devices include a camera phone, a personal digital assistant (PDA), a personal computer (PC), a network-enabled camera, and the like. Each device, e.g., 400a, includes at least one presence client 410a that is configured to communicate with the presence service 220 using a presence communication protocol. In one embodiment, the client 410a can be a browser, as disclosed in co-pending U.S. patent application Ser. No. 11/160,612 entitled “METHOD AND APPARATUS FOR BROWSING NETWORK RESOURCES USING AN ASYNCHRONOUS COMMUNICATIONS PROTOCOL,” filed on Jun. 30, 2005, and commonly owned with the present application and herein incorporated by reference.

In one embodiment, the client devices 400 are configured to communicate with each other and with at least one presence server 200 via a network 110, such as the Internet. As is shown, a proxy service 152 hosted by a server 150 serves as a proxy among the devices 400 in the network 110. The proxy service 152 permits the devices 400 and the presence service 220 to communicate with one another through firewalls, such as firewall 204, in a known manner. In one embodiment, the proxy service 152 can be associated with the presence service 220 and/or associated with at least one of the client devices 400. While shown residing in a separate server 150, the proxy service 152 can also reside in the presence server 200. In addition, while only one proxy service 152 is shown in FIG. 1, a plurality of proxies 152 can be implemented to handle network access to and from client devices 400 that are protected by one or more firewalls 204.

As is shown, the presence server 200 hosts the presence service 220. The presence service 220 is configured to process subscriptions by presence clients 410 to information published by other presence clients 410. In an exemplary embodiment, tuple data and subscription information can be stored in a tuple data store 240 and a subscription data store 235, respectively. The data stores 235, 240 can include files, in memory caches, and databases, for example. In one embodiment, all data can be treated as tuple data meaning that it can be formatted for transfer using a data format compatible with the pub/sub communication protocol supported by the presence service 220. While the tuple data store 240 is shown separate from the subscription data store 240, the tuple data and the subscription information can also be stored in a single data store. Moreover, although the data stores 235, 240 are depicted as having a particular location remote from the devices 400, nothing prevents them from being stored in another location. For example, all or a portion of the information may be stored in a memory structure (not shown) on the devices 400 or on another memory structure (not shown).

While the system 100 is described in terms of presence clients 410 using presence protocols for communicating with the presence server 200, other systems providing for the distribution of a status value associated with a principal can be provided. Such systems, which include presence-based systems, can be referred to as status distribution systems and are considered within the scope of the methods, systems, and program products described.

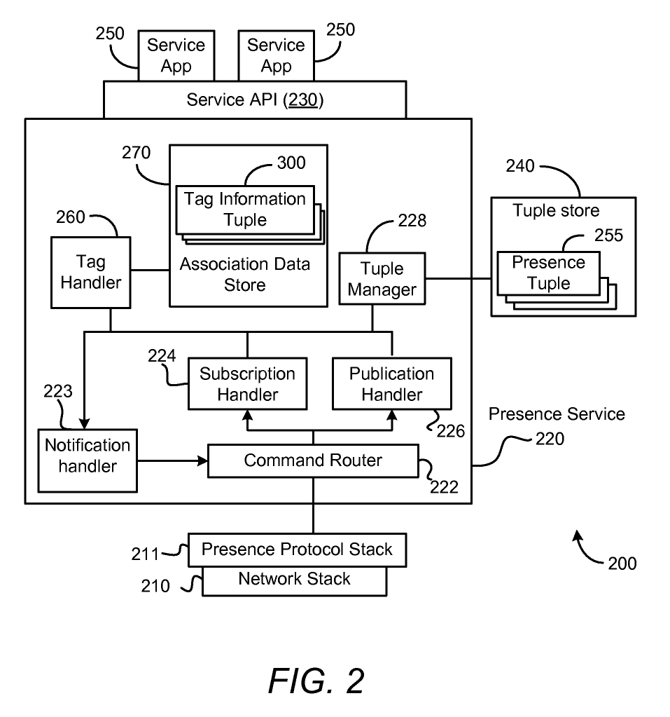

FIG. 2 is a block diagram of an exemplary presence server 200 according to one embodiment. The server 200 includes a presence protocol stack component 211 coupled to a network stack component 210. The network stack component 210 is used to exchange information received or transmitted at the physical layer (e.g., the wire, air interface, or fiber optic cable) of the network 110, through the data link (e.g., ETHERNET, 802.11 WIFI), transport/network (e.g., TCP/IP) and application (e.g., XMPP) layers of the stack. The presence protocol stack component 211 processes presence commands received from the network 110 and passes the commands to the presence service 220.

The presence service 220 includes a command router 222 configured to receive and process presence commands from the presence protocol stack component 211. In one embodiment, the command router 222 directs subscribe commands to a subscription handler 224 that is configured to handle subscribe commands, directs publish commands to a publication handler 226 that is configured to handle publish commands, and sends notify commands on behalf of a notification handler 223. The command router 222 can also be configured to process other pub/sub commands, such as PROBE and FETCH/POLL.

The subscription handler 224 processes subscribe commands and other tasks associated with subscriptions. In one embodiment, the subscription handler 224 processes a subscribe command by placing a subscribing client identifier, e.g., 410a, on a subscription list associated with a tuple. In addition, the subscription handler 224 authenticates and authorizes the client 410a, manages rosters and subscription lists, and uses the notification handler 223 to construct notification response messages informing clients 410a-410c when information that is subscribed to has been updated. The publication handler 226 processes publish commands and coordinates with the subscription handler 224 the publication of tuple data to ensure that subscribing clients 410a-410c, if any, are notified via the notification handler 223.

In one embodiment, the presence service 220 is configured to host one or more service applications 250 via a service application programming interface (API) 230. Such a configuration is described in co-pending U.S. patent application Ser. No. 11/323,762 entitled “METHOD AND APPARATUS FOR PROVIDING CUSTOMIZED SUBSCRIPTION DATA,” filed on Dec. 30, 2005, and commonly owned with the present application and herein incorporated by reference. In one embodiment, the service API 230 enables the presence service 220 to pass subscription notification messages to any one of the service applications 250. Because the service API 230 is independent of both the transport and pub/sub protocol, messages can be exchanged freely and securely between the presence service 220 and any of the service applications 250.

The presence service 220 also includes a tuple manager 228 for managing presence tuples 255 and published information in the tuples 255. In one embodiment, the tuple manager 228 can be configured also to manage rosters for security purposes and to store and to retrieve tuple data from the tuple store 240. If the presence service 220 archives published information, the tuple manager 228 can also be configured to archive and to retrieve the archived published information.

In an exemplary embodiment, the presence service 220 includes means for receiving, from a first presence client 410a associated with a first principal, a first status value associated with the first principal, and means for sending a first message including the first status value associated with the first principal to a second presence client 410b associated with a second principal. For example, the publication handler 226 and the notification handler 223, both described above, can be configured to perform these tasks respectively.

According to one embodiment, the presence service 220 also includes means for receiving, from the second client 410b associated with the second principal, a tag associated with the first status value of the first principal, and for storing an association between the received tag and the first status value in a data store. For example, the presence service 220 can include a tag handler component 260 to perform these functions. According to an exemplary embodiment, the tag handler component 260 can receive the tag via the publication handler 226. The publication handler 226 receives a message from the second client 410b that includes tag information. The tag information comprises the tag and information associating the tag with the first status value of the first principal. In one embodiment, the publication handler 226 provides the tag information to the tag handler component 260, which stores the information in a data store 270.

In one embodiment, the tag handler component 260 can be a standalone component coupled to the other components of the presence service 220 (shown in FIG. 2). In other embodiments, the tag handler component 260 can be one of the service applications 250 coupled to the presence service 220 via the service API 230, or alternatively, the tag handler component 260 can be integrated with the publication handler 226.

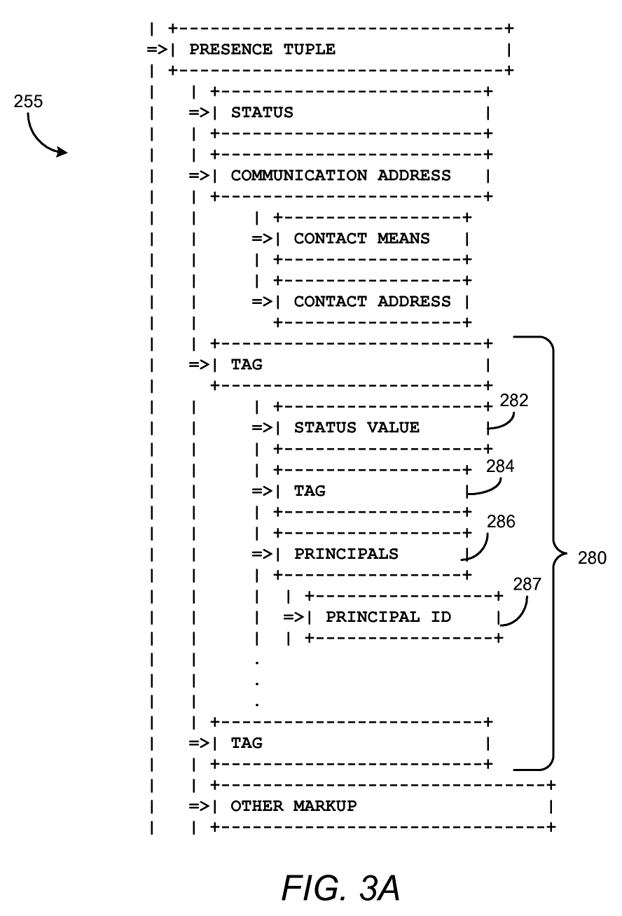

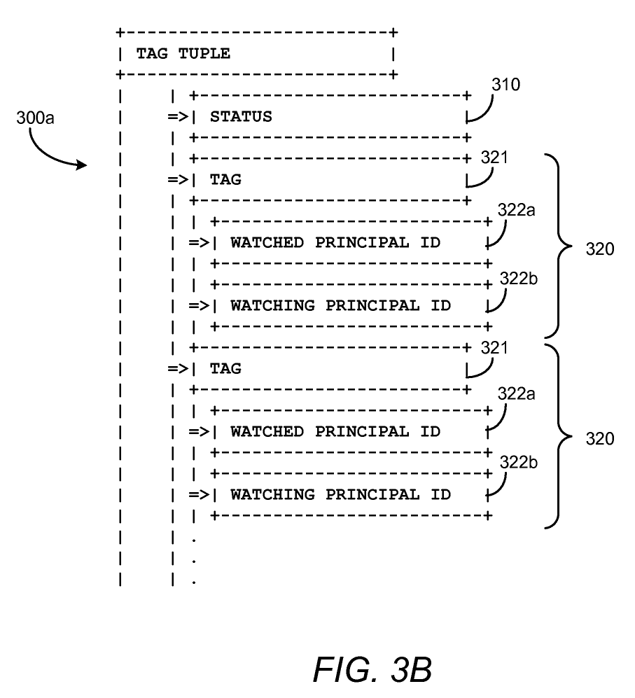

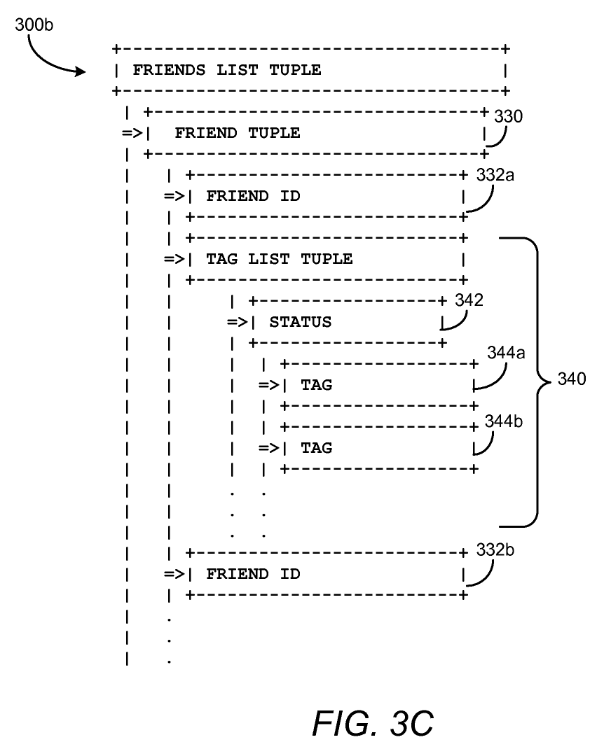

The tag handler component 260 can receive and store the tag information in a variety of data formats. For example, FIG. 3A illustrates an exemplary data model of a tuple including tag information that associates a tag with a status value of a principal. In this example, the tuple is a presence tuple 255 associated with the second principal. The presence tuple 255 includes a status element, which carries a status value associated with the second principal, and a communication address element that includes contact means and contact address sub elements.

The presence tuple 255 can also include a tag element 280. In one embodiment, the tag element 280 can include respective sub elements for carrying a status value 282 and an associated tag 284. In addition, the tag element 280 can include a principals element 286 that includes a principal ID element 287 for carrying an identifier of a principal associated with the tag 284 and the status value 282. In one embodiment, more than one principal can be associated with the status value 282 and the tag 284. While only one tag element 284 is shown, multiple tags can be associated with a status value 282, and vice versa, i.e., multiple status values 282 can be associated with a tag 284. Moreover, multiple status values 282 can be associated with multiple tags 284. Because the tag information is provided by the principal associated with the presence tuple 255, e.g., the second principal, this data format is suitable for supporting private tags assigned by a principal for status values associated with other principals.

FIG. 3B illustrates another exemplary data model of a tuple including tag information. In this embodiment, the tag information is provided in a tag information tuple 300 that comprises a tag tuple 300a. The tag tuple 300a includes a status element 310 for providing a status value and one or more tag elements 320. Each tag element 320 supports a sub-tuple including a tag 321 and one or more sub-tuples including an identifier of a watched principal 322a with which the status value and tag is associated by a watching principal 322b. As with the previously described data model, variations of the model support one-to-one, one-to-many, and many-to-many associations between status values, tags, and/or principals. In one embodiment, tag tuples 300a can be stored separately from the presence tuples 255. Accordingly, tag tuples 300a can be better suited for sharing of tags among principals because the tag information is not embedded in a presence tuple 255 of a principal along with potentially sensitive information.

FIG. 3C illustrates yet another exemplary data model of a tuple including tag information. In this embodiment, the tag information is provided in a tag information tuple that comprises a friends list tuple 300b. The format extends an exemplary format for transmitting a friends list including zero or more friend tuples 332a, 332b where each friend tuple 332a is associated with a watched principal. In one embodiment, each friend element 332a can include a tag list tuple 340 that includes a status element 342 for carrying a status value and one or more tag elements 344a, 344b for carrying tags associated with the status value. The principal associated with the status value and the tag is identified by the friend ID and the assignor or user of the tag is the owner of the friends list tuple 300b. This data model can be useful for sharing tags among a group of principals identified in the friends list.

The exemplary tuples described in FIGS. 3A-3C illustrate that the tag information can be provided in a tuple associated with various entities including the second principal (via the presence tuple 255), the first principal (via the friends list tuple 300b), and the status value and the tag (via the tag tuple 300a). In another embodiment, the tag information can be provided in a presence tuple that identifies at least a portion of a presence tuple of the first principal and is associated with the first principal's presence tuple. Such a tuple is described in co-pending U.S. Patent application Ser. No. 11/609,405, entitled “METHOD AND SYSTEM FOR ANNOTATING PRESENCE INFORMATION,” filed on Dec. 12, 2006, commonly owned with the present application, and incorporated here by reference in its entirety.

Those skilled in the art would readily recognize that the tag information can include additional information and that the tuples can, and most likely would, include additional elements and/or sub-tuples to carry the additional information. For instance, in one embodiment, the tag information can include metadata associated with the tag. The metadata can include, for example, one or more conditions that define when an association is valid, i.e., when the tag is associated with the first status value of the first principal. The exemplary tuples can be extended to provide suitable elements and sub-tuples to carry the metadata.

Referring again to FIG. 2, the presence service 220 further includes means for providing a second message including the tag to the presence client 410b associated with the second principal when the status of the first principal is updated to the first status value. For example, the subscription handler 224, described above, can be configured to perform this function in cooperation with the notification handler 223 and command router 222.

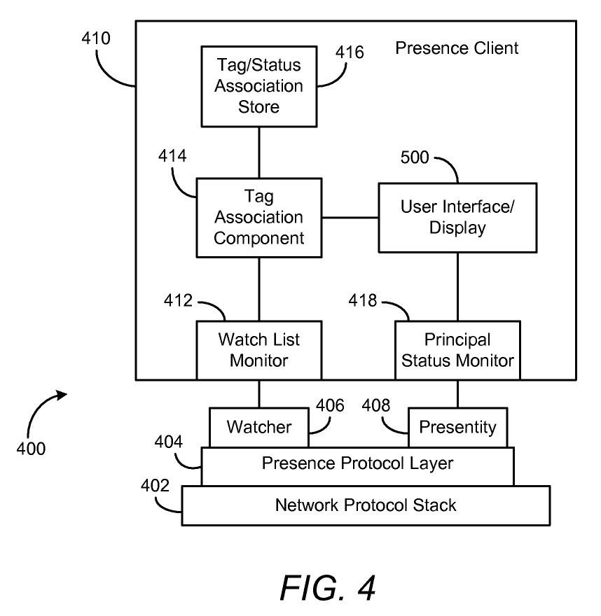

FIG. 4 is a block diagram illustrating an exemplary client device 400 according to one embodiment. The client device 400 includes a presence client 410 that is configured to communicate with the presence service 220 using a presence communication protocol. The presence client 410 operates within an operating environment (not shown) including, for example, a processor, a processor memory, a persistent memory, and an operating system including a user interface subsystem and a network subsystem (not shown) of the client device 400. In one embodiment, the presence client 410 can send and receive information to and from the presence server 200 via a presence protocol layer 404 and a network protocol stack component 402. The network protocol stack component 402 is used to exchange information received or transmitted at the physical layer of the network 110, through the data link, transport/network and application layers of the stack. The presence protocol layer 404 processes messages received from the presence server 200 over the network 110.

The presence client 410 includes a presentity component 408 and a principal status monitor (PSM) component 418 associated with the presence client 410. The PSM 418 can be integrated into the client 410 (as shown) or external to the client 410. In one embodiment, the PSM 418 is configured to act as an agent on behalf of the principal and to use the presentity component 408 to publish information, e.g., the principal's status and other presence information, to the presence server 200. For example, the PSM 418 can publish information by using the presentity 408 to create a message including the information and sending the message via the network 110 to the presence service 220, where it is received and processed by the publication handler 226.

The client device 400 also includes a watcher component 406 and a watch list monitor (WLM) component 412 associated with the presence client 410. In one embodiment, the watcher component 406 translates requests between the presence server 200 and the WLM 412, that is, it translates between the presence communication protocol of the server 200 and the data format used by the WLM 412 (typically proprietary). The watcher component 406 serves watching/subscribing clients 410 by sending, for example, subscribe commands on behalf of the WLM 412 and by routing notification messages to the WLM 412.

The WLM 412 can be integrated into the client 410 (as shown) or external to the client 410. In one embodiment, WLM 412 monitors a friends list on behalf of the user and/or principal of the presence client 410. The WLM 412 receives current status values associated with principals corresponding to the friends on the list via the network 110 from the presence service 220. The WLM 412 provides a received status value associated with a watched principal to a user interface/display 500 for presenting the current status of the watched principal to the user of the device 400.

According to an exemplary embodiment, the presence client 410 is associated with a second principal and includes means for receiving a first message from the presence service 220 that includes a first status value associated with a first principal. For example, the WLM component 412, described above, can be configured to receive the first message that includes the first status value associated with the first principal. In one embodiment, the first message is received first by the watcher component 406 via the presence protocol layer 404 and network protocol stack component 402. The watcher component 406 then routes the first message to the WLM component 412 for processing.

In one embodiment, the presence client 410 also includes means for receiving a tag distinct from and associated with the first status value of the first principal, for receiving metadata for the tag, and for storing an association between the tag, its metadata and the first status value. For example, the presence client 410 can include a tag association component 414 to perform these functions. In one embodiment, the tag association component 414 can be configured to provide a tag dialog box on the user interface 500. The tag dialog box allows the tag association component 414 to receive the tag to be associated with the first status value and the metadata for the tag.

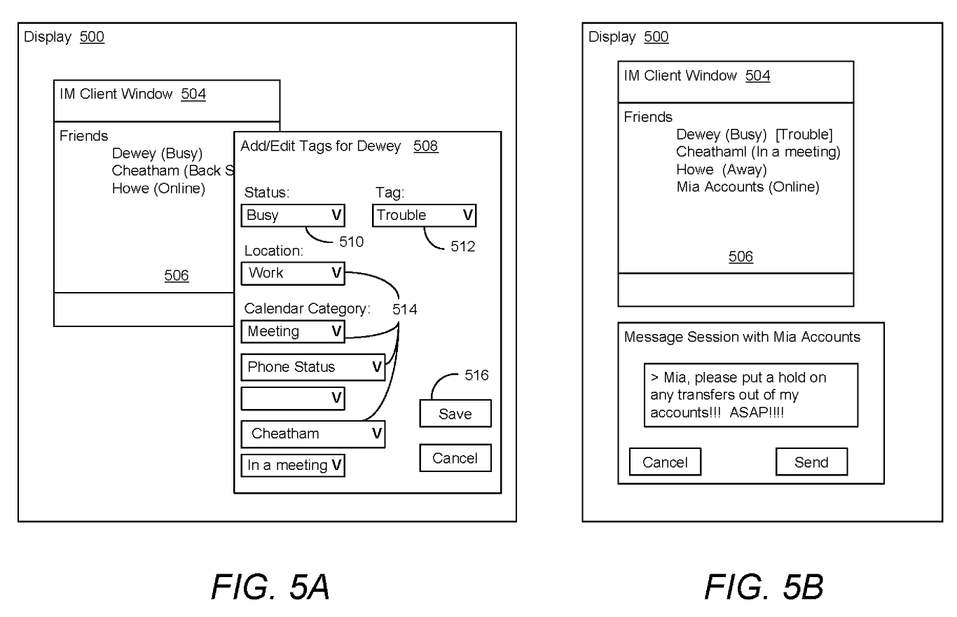

FIG. 5A is an exemplary user interface/display 500 including a tag dialog box according to one embodiment. In one embodiment, the display 500 provides an IM client window 504 including a friends pane 506. The friends pane 506 presents principals in a friends list and their corresponding status values. For example, in the friends pane 506, the status value, “Busy,” is associated with the principal, “Dewey.” The tag association component 414 provides the tag dialog box 508 on the display 500 in response to receiving an input indication that tag information is to be received. For example, a tagging principal, e.g., the second principal, can place a mouse pointer above a principal, e.g., “Dewey,” in the friends pane 506, and provide a control-left mouse click to indicate that tag information is to be submitted for Dewey. In response to the mouse click, the tag association component 414 presents the tag dialog box 508.

In one embodiment, the tag dialog box 508 provides a tag box 512 for receiving at least one of a text string, an image, or a media stream representing the tag that is to be associated with the status of the identified principal. In one embodiment, the tag box 512 can include a drop down list that provides a list of tags from which the tagging principal can select the tag. The tags in the list can include previously provided tags, which can be pre-specified and provided by the presence client 410 and/or the presence service 220. For example, the listed tags can be those previously entered by the tagging principal in tagging the status values of other principals.

In one embodiment, the listed tags can also be provided by any principal or agent in communication with the presence service 220 either directly or indirectly through another presence service, proxy, and/or agent. For example, the first message received from the presence service 220 can include the first status value of the first principal along with a few suggested tags, and the list of tags can include the suggested tags as well as other tags for use by the tagging principal. According to one embodiment, the listed tags can be filtered based on the identity of the tagging principal or based on a group the tagging principal is included as a member. A group can represent a role, a type, a current status, a time/date, and/or a location of the tagging principal and/or the tagged principal.

The tag dialog box 508 also provides a status box 510 that indicates the current status of the identified principal, Dewey, with which the tag is to be associated. In one embodiment, the status box 510 can include a drop down list that includes other known status values that have been associated with the first principal, “Dewey.” The current status value of the associated principal can be presented by default, and the second principal can select a different status value by opening the drop down list and selecting one of the displayed known status values.

In another embodiment, the tag dialog box 508 allows the tagging principal to provide metadata for the tag. In one embodiment, the metadata includes at least one condition that determines when the tag should be associated with the status value of the identified principal. For example, the tag may be associated with metadata 514 that includes conditions related to a location of the identified principal, such as “work” or “home,” a calendar category, such as “Meeting,” indicating the identified principal's calendar has a scheduled meeting when the status value is associated with the identified principal, and/or a principal's phone status. The condition can also be based on the status of another principal. For example, the tag dialog box 508 shown in FIG. 5A indicates that the association between the status value, “Busy,” of the identified principal, “Dewey” is to be associated with the tag, “Trouble,” when the following conditions are satisfied: Dewey's status is “Busy” and Dewey is at work, in a meeting, and the principal “Cheatham” is in a meeting as indicated by Cheatham's status and/or calendar. Otherwise the association is inactive.

Alternately, or in addition to providing the tag dialog box 508 on the user interface/display 500, the tag association component 414 can provide a programming interface (not shown). In one embodiment, the programming interface allows other components of the presence client 410 and/or other applications to select the tag associated with the status value of a principal.

Referring again to FIG. 4, after the tag association component 414 receives an input indicating an association has been configured, e.g., the selection of a “Save” button 516 in the tag dialog box 508, the tag association component 414 can store an association between the status value of the identified principal, the tag and the metadata. In one embodiment, the association is stored in a tag/status association data store 416 associated with the presence client 410. Alternatively, or in addition, the tag association component 414 can store the association at a remote system, such as the presence server 200.

According to one embodiment, the tag association component 414 can send a message that includes tag information to the presence service 220 via the network 110. The tag information can include the tag and information associating the tag with the first status value of the first principal. The tag information can also include the metadata for the tag. In one embodiment, the tag association component 414 uses the PSM 418 and the presentity 408 to publish the tag information in the message to the presence service 220. The tag information can be provided in the message according to the exemplary data models discussed above in FIGS. 3A-3C.

In one embodiment, the presence client 410 also includes means for presenting the tag when a status of the first principal is updated to the first status value and when each of the conditions in the metadata for the tag is satisfied. For example, the user interface/display 500 can be configured to present the tag under these conditions. In one embodiment, shown in FIG. 5B, the user interface/display 500 provides the IM Client Window 504 and the friends pane 506. The tag, e.g., “Trouble,” can be displayed alone or along with the first status value, e.g., “Busy,” for the principal Dewey in the friends pane 506 according to the tag configuration shown in FIG. 5A. Presumably, each of the conditions specified in the metadata has been satisfied. Otherwise, the tag “Trouble” would not be presented.

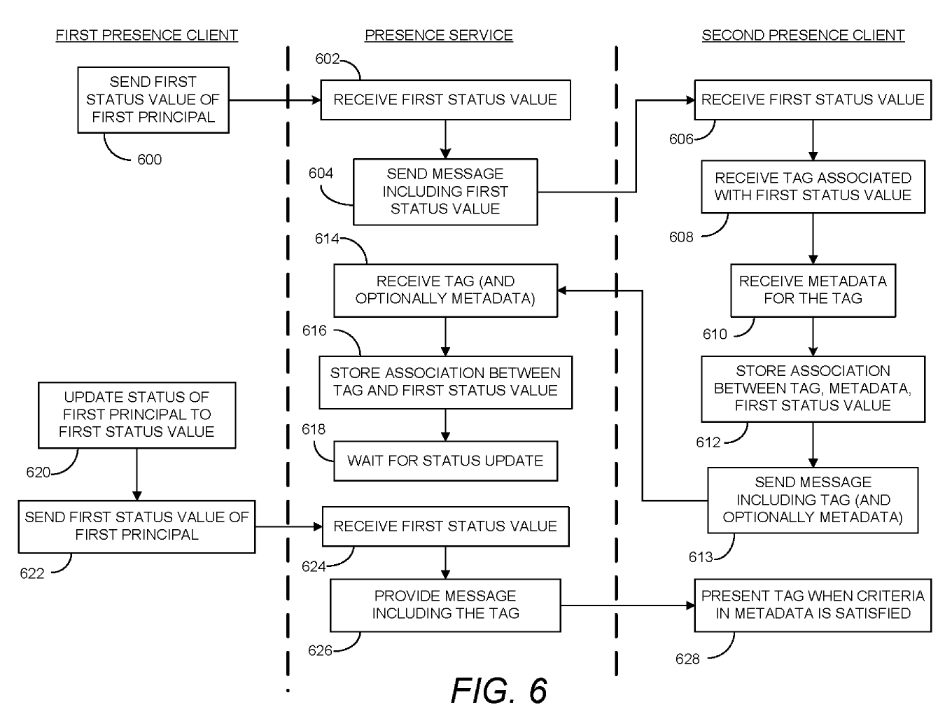

FIG. 6 is a flow diagram illustrating a method for associating a tag with a status value of a principal according to an exemplary embodiment. Referring to FIGS. 1-6, the method begins when a first presence client 410a associated with a first principal sends a first status value of the first principal to the presence service 220 (block 600). For example, in one embodiment, the first client 410a can use the PSM 418 and presentity component 408 to publish the first status value in a first message to the presence service 220 via the presence protocol layer 404 and network protocol stack component 402 using a presence communication protocol.

The presence service 220 receives the first message that includes the first status value from the first presence client 410a (block 602) and proceeds to process the message. For example, when the first message is received at the presence service 220, it is routed by the command router 222 to the publication handler 226. The publication handler 226 updates and/or creates a storage area for the status value in the first message. In one embodiment, a status element in a presence tuple 255 associated with the first principal is updated with the status value in the first message.

The publication handler 226 also invokes the subscription handler 224, which maintains a subscription list for each tuple associated with a principal, including the first principal. The subscription list identifies which, if any, principals are subscribed to receive status updates of the first principal. When invoked, the subscription handler 224 checks the subscription list associated with the tuple of the first principal, and uses the notification handler 223 to send a second message including the first status value associated with the first principal to each of the subscribers, including a second presence client 410b associated with a second principal (block 604).

In one embodiment, in addition to the first status value, the second message can also include a plurality of possible tags that can be associated with the first status value. The plurality of possible tags can be provided by the first principal, the presence service 220, or any other principal, including the second principal, or agent of the presence service 220. In another embodiment, another message related to the second message can be sent to the second presence client 410, where the related message includes the plurality of possible tags for the first status value.

The second presence client 410b receives the second message that includes the first status value associated with the first principal from the presence service 220 (block 606). In one embodiment, the second message is received by the WLM 412 via the watcher component 406, the presence protocol layer 404 and the network protocol stack component 402. The WLM 412 processes the second message and presents the first status value associated with the first principal in the user interface/display 500. In one embodiment, the first principal is a friend on the second principal's friends list and the identifier of the first principal and the first status value are displayed along with the identifiers of other principals and their respective status values in the friends pane 506 of the IM Client Window 504.

When the first status value associated with the first principal is received and presented, the second principal may elect to associate a tag with the first status value and to provide metadata for the tag by invoking the tag association component 414. In one embodiment, when the tag association component 414 is invoked, it allows the second principal to select the tag from among a list of tags and to specify metadata for the tag via the user interface/display 500 and/or the programming interface. In one embodiment when the second message includes the first status value and a plurality of possible tags, the list of tags includes the plurality of possible tags. When selected and specified, the tag association component 414 receives the tag associated with the first status value (block 608) and receives the metadata for the tag (block 610).

Once the tag associated with the first status value and the metadata for the tag have been received, the tag association component 414 optionally stores an association between the tag, its metadata and the first status value in the tag/status association data store 416 (block 612). In addition, the tag association component 414 sends a third message including tag information comprising the tag, information associating the tag with the first status value and, optionally, the metadata for the tag, to the presence service 220 (block 613).

The presence service 220 receives the third message that includes the tag associated with the first status value of the first principal (block 614) over the network 110 via the presence protocol stack 211 and network stack component 210. In one embodiment, when the third message is received at the presence service 220, it is routed by the command router 222 to the publication handler 226. When the publication handler 226 detects the tag information in the message, the tag information is provided to the tag handler component 260.

As stated above, the tag information includes the tag, information associating the tag with the first status value of the first principal, and optionally metadata for the tag. The tag handler component 260 receives the tag information and stores the information in an association data store 270 (block 616). In one embodiment, when the tag information is provided in a tag information tuple 300, e.g., FIGS. 3B and 3C, the tag information tuple 300 can be stored in the association data store 270. In another embodiment, when the association is provided in a presence tuple 255, e.g., FIG. 3A, the association can be stored in the presence tuple 255. In addition, the tag information can be parsed from the presence information and the association between the tag and the first status value can be stored in the association data store 270. Once the tag information is stored, the presence service 220 waits for a status update (block 618).

When the first presence client 410a associated with the first principal updates the first principal's status to the first status value (block 620), it publishes the first status value by sending it to the presence service 220 (block 622) in a fourth message. The presence service 220 receives the fourth message including first status value from the first presence client 410a (block 624), and routes the message to the publication handler 226. The publication handler 226 updates the presence tuple 255 of the first principal with the first status value and invokes the subscription handler 224, which processes any subscribers in the subscription list of the updated presence tuple 255. For example, the subscription handler identifies subscribers in the subscription list, including the second presence client 410b associated with the second principal, and invokes the notification handler 223 to send a notification message to each subscriber.

In one embodiment, in addition to identifying subscribers, such as the second principal, the subscription handler 224 invokes the tag handler component 260 to determine whether the subscriber, e.g., the second principal, has defined an association between the first status value and a tag. In this example, the tag handler component 260 determines that the second principal has defined such an association and returns the tag associated with the first status value from the association data store 270.

In one embodiment, when the subscription handler 224 receives the tag, it invokes the notification handler 223 to provide a notification message that includes the tag and the presence information to the second presence client 410b associated with the second principal (block 626). In an alternate embodiment, two related messages can be sent—a primary message that includes the updated status element with the first status value, and a secondary message including the information associating the tag with the first status value. In this embodiment, the two messages can be correlated by the second presence client 410b using a correlator, such as, for example, an identifier of the first principal.

In another embodiment where metadata for the tag is stored by the presence service 220 in the association data store 270, the tag handler 260 retrieves and returns the metadata along with the tag. When the subscription handler 224 receives the metadata for the tag, the subscription handler 224 can determine whether each of the conditions specified in the metadata is satisfied before the tag is provided to the second presence client 410b. When the conditions are not satisfied, the tag is not provided.

In another exemplary embodiment, the subscription handler 224 is configured to determine a relationship between the second principal and a third principal. For example, the second principal and the third principal can be members of a group and the group can be a subscriber in the subscription list of the updated presence tuple 255. In this case, the subscription handler 224 can invoke the notification handler 223 to provide and send one or more messages including the tag and the first status value associated with the first principal to a third presence client 410c associated with the third principal based on the relationship between the second and third principals.

The notification message including the tag associated with the first status value of the first principal is received by the second client device 410b associated with the second principal. In one embodiment, the message is received by the WLM 412, which processes the message. For example, in one embodiment, WLM 412 detects the tag and invokes the tag association component 414. The tag association component 414 can retrieve the tag and the metadata for the tag from the tag/status association data store 416. When the tag association component 414 determines that each of the conditions in the metadata is satisfied, the tag associated with the first status value of the first principal can be presented in the user interface/display 500 (block 628). In one embodiment, the tag is displayed along with the first status value and the identifier of the first principal in a friends pane 506 shown in FIG. 5B. In another embodiment, the tag is displayed in place of the status value.

Note that because the tag association information can be stored locally by the client device 400b, the second presence client 410b can retrieve the information associating the tag with the first status value of the first principal whenever a notification message that includes the first status value for the first principal is received. For example, such a message can be received from another presence service 220 that does not store the tag information. In this case, the WLM 412 can invoke the tag association component 414, which can use the first status value to look up and retrieve the associated tag and metadata.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for associating a tag with a status value of a principal, the method comprising:
receiving, from a client of a presence service associated with a first principal, a first status value associated with the first principal;
sending, via the presence service, a first message including the first status value associated with the first principal to a client of the presence service associated with a second principal;
receiving from the client associated with the second principal a tag associated with the first status value of the first principal, wherein the tag is distinct from the first status value;
storing an association between the received tag and the first status value of the first principal; and
providing based on the association a second message including the tag to the client associated with the second principal when a status of the first principal is updated to the first status value such that the tag is presented to the second principal.

2. The method of claim 1 wherein at least one of receiving the tag and providing the second message comprises using the presence service and a presence protocol to at least one of receive the tag and provide the second message.

3. The method of claim 1 wherein storing the association includes storing association information in at least one element of a tuple, wherein the tuple is associated with at least one of the second principal, the first principal, the first status value, and the tag.

4. The method of claim 3 wherein the tuple is a presence tuple associated with at least one of the second principal and the first principal.

5. The method of claim 1 wherein sending the first message includes:
providing in one of the first message and a third message associated with the first message a plurality of possible tags, wherein the tag associated with the first status value of the first principal is selected from the plurality of possible tags.

6. The method of claim 1 wherein receiving the tag includes receiving metadata for the tag, wherein the metadata comprises at least one condition that determines when the tag is associated with the first status value of the first principal.

7. The method of claim 6 wherein prior to providing the tag, the method further includes determining whether each of the at least one conditions is satisfied and providing the tag when each of the at least one conditions is satisfied.

8. The method of claim 1 wherein providing the second message includes generating a notification message including the tag and transmitting the notification to the client associated with the second principal.

9. The method of claim 1 further comprising:
determining a relationship between the second principal and a third principal;
providing in one of a third message and a fourth message associated with the third message the tag received from the second principal based on the relationship between the second principal and the third principal; and
sending at least one of the third message and the fourth message including the received tag and the first status value associated with the first principal to a client associated with the third principal.

10. A method for associating a tag with a status value of a principal, the method comprising:
receiving, from a presence service, a first message including a first status value associated with a first principal, the first message received by a presence client of the presence service associated with a second principal;
receiving a tag associated with the first status value of the first principal, wherein the tag is distinct from the first status value;
receiving metadata for the tag, the metadata including at least one condition that determines when the tag is associated with the first status value of the first principal;
storing an association between the tag, its metadata and the first status value; and
presenting the tag when a status of the first principal is updated to the first status value and when each of the at least one conditions is satisfied.

11. The method of claim 10 wherein receiving the tag comprises using the presence service and a presence protocol to receive the tag.

12. The method of claim 10 further comprising displaying the first status value in a user interface of the second principal along with a plurality of status values associated with a plurality of watched principals.

13. The method of claim 10 wherein receiving the tag includes allowing the second principal to select the tag from among a list of tags via at least one of a user interface and a programming interface of a device hosting the presence client associated with the second principal.

14. The method of claim 10 wherein the first message further includes a plurality of possible tags, the method comprising displaying on a user interface a list of tags including the plurality of possible tags, the first status value, and an identifier of the first principal.

15. The method of claim 10 wherein receiving metadata for the tag includes specifying at least one of a location of the first principal, a calendar category, and a status of another principal including the second principal.

16. The method of claim 10 wherein storing the association includes storing the association in a data store of a device hosting the presence client.

17. The method of claim 16 wherein prior to presenting the tag the method further includes determining whether each of the at least one conditions is satisfied and retrieving the tag from the data store when each of the at least one conditions is satisfied.

18. The method of claim 10 wherein storing the association includes sending a second message including the tag, the metadata, and information associating the tag with the first status value to a remote system.

19. The method of claim 18 wherein prior to presenting the tag, the method further includes receiving from the remote system a third message that includes the tag when the remote system determines that a status of the first principal has been updated to the first status and when each of the at least one conditions is satisfied.

20. A system for associating a tag with a status value of a principal, the system comprising:
a publication handler component configured to receive, from a client of a presence service associated with a first principal, a first status value associated with the first principal;
a notification handler component configured to send a first message including the first status value associated with the first principal to a client of the presence service associated with a second principal;
a tag handler component configured to receive from the client associated with the second principal a tag associated with the first status value of the first principal, wherein the tag is distinct from the first status value, and configured to store an association between the received tag and the first status value of the first principal in a data store; and
a subscription handler component configured to provide based on the association a second message including the tag to the client associated with the second principal when a status of the first principal is updated to the first status value such that the tag is presented to the second principal.

21. The system of claim 20 wherein the data store comprises a plurality of data tuples and the tag handler component is configured to store the association between the received tag and the first status value of the first principal in at least one element of a tuple of the plurality of data tuples, wherein the tuple is associated with at least one of the second principal, the first principal, the first status value, and the tag.

22. The system of claim 21 wherein the tuple is a presence tuple associated with at least one of the second principal and the first principal.

23. The system of claim 20 wherein the tag handler is configured to receive metadata for the tag, wherein the metadata comprises at least one condition that determines when the tag is associated with the first status value of the first principal.

24. The system of claim 23 wherein prior to providing the tag, the subscription handler component is further configured to determine whether each of the at least one conditions is satisfied and to provide the tag when each of the at least one conditions is satisfied.

25. The system of claim 20 wherein the subscription handler component is configured to determine a relationship between the second principal and a third principal and to provide in one of a third message and a fourth message associated with the third message the tag received from the second principal based on the relationship between the second principal and the third principal, and the notification handler component is configured to send at least one of the third message and the fourth message including the received tag and the first status value associated with the first principal to a client associated with the third principal.

26. A server including a presence service comprising the system of claim 20 and a communication interface configured to send and receive data to and from a plurality of presence clients associated with a plurality of principals via a network.

27. A system for associating a tag with a status value of a principal, the system comprising:
a watch list monitor component configured to receive, from a presence service, a first message including a first status value associated with a first principal;
a tag association component configured to receive a tag associated with the first status value of the first principal, wherein the tag is distinct from the first status value, to receive metadata for the tag, the metadata including at least one condition that determines when the tag is associated with the first status value of the first principal, and to store an association between the tag, its metadata and the first status value; and
a user interface component configured to present the tag on a display when a status of the first principal is updated to the first status value and when the at least one condition is satisfied.

28. The system of claim 27 wherein the first message further includes a plurality of possible tags and the tag association component is configured to use the user interface component to present on the display a list of tags including the plurality of tags, the first status value and an identifier of the first principal.

29. The system of claim 27 wherein the at least one condition in the metadata relates to at least one of a location of the first principal, a calendar category, and a status of another principal including the second principal.

30. The system of claim 27 further comprising a data store for storing the association, and wherein when the status of the first principal is updated to the first status value, the tag association component is further configured to determine whether each of the at least one conditions is satisfied and to retrieve the tag from the data store when each of the at least one conditions is satisfied.

31. The system of claim 27 wherein the tag association component is configured to store the association by sending a second message including the tag, the metadata and information associating the tag with the first status value to a remote system.

32. The system of claim 31 wherein the watch list monitor component is configured to receive from the remote system a third message that includes the tag when the remote system determines that a status of the first principal has been updated to the first status and when each of the at least one conditions is satisfied.

33. A client device including a presence client comprising the system of claim 27 and a communication interface configured to send and receive data to and from a presence service via a network.

34. A computer readable medium containing a computer program, executable by a machine, for associating a tag with a status value of a principal, the computer program comprising executable instructions for:
receiving, from a client of a presence service associated with a first principal, a first status value associated with the first principal;
sending, via the presence service, a first message including the first status value associated with the first principal to a client of the presence service associated with a second principal;
receiving from the client associated with the second principal a tag associated with the first status value of the first principal, wherein the tag is distinct from the first status value;
storing an association between the received tag and the first status value of the first principal; and
providing based on the association a second message including the tag to the client associated with the second principal when a status of the first principal is updated to the first status value such that the tag is presented to the second principal.

35. The computer readable medium of claim 34 wherein the program further includes instructions for:
receiving metadata associated with the tag, wherein the metadata comprises at least one condition that determines when the tag is associated with the first status value of the first principal; and
determining whether each of the at least one conditions is satisfied prior to providing the tag to the client associated with the second principal.

36. A computer readable medium containing a computer program, executable by a machine, for associating a tag with a status value of a principal, the computer program comprising executable instructions for:
receiving, from a presence service, a first message including a first status value associated with a first principal, the first message received by a client of the presence service associated with a second principal;
receiving a tag associated with the first status value of the first principal, wherein the tag is distinct from the first status value;
receiving metadata for the tag, the metadata including at least one condition that determines when the tag is associated with the first status value of the first principal;
storing an association between the tag, its metadata and the first status value; and
presenting the tag when a status of the first principal is updated to the first status value and when the at least one condition is satisfied.

37. A system for associating a tag with a status value of a principal, the system comprising:
means for receiving, from a client of a presence service associated with a first principal, a first status value associated with the first principal;
means for sending, via the presence service, a first message including the first status value associated with the first principal to a client of the presence service associated with a second principal;
means for receiving from the client associated with the second principal a tag associated with the first status value of the first principal, wherein the tag is distinct from the first status value, and storing an association between the received tag and the first status value of the first principal in a data store; and
means for providing based on the association a second message including the tag to the client associated with the second principal when a status of the first principal is updated to the first status value such that the tag is presented to the second principal.

38. A system for associating a tag with a status value of a principal, the system comprising:
means for receiving, from a presence service, a first message including a first status value associated with a first principal, the first message received by a client of the presence service associated with a second principal;
means for receiving a tag associated with the first status value of the first principal, wherein the tag is distinct from the first status value, for receiving metadata for the tag, the metadata including at least one condition that determines when the tag is associated with the first status value of the first principal, and for storing an association between the tag, its metadata and the first status value; and
means for presenting the tag when a status of the first principal is updated to the first status value and when the at least one condition is satisfied.
